(19) United States
(12) Patent Application Publication
(10) Pub. No.: US 2012/0031883 A1
(43) Pub. Date: Feb. 9, 2012

(54) LASER MACHINING DEVICE AND LASER MACHINING METHOD

(75) Inventors: Kenji Kumamoto, Chiyoda-ku (JP); Yushi Takenaka, Chiyoda-ku (JP); Kazuki Kuba, Chiyoda-ku (JP); Toru Murai, Chiyoda-ku (JP); Taira Ogita, Chiyoda-ku (JP); Junichi Nishimae, Chiyoda-ku (JP); Keisuke Furuta, Chiyoda-ku (JP)

(73) Assignee: MITSUBISHI ELECTRIC CORPORATION, Chiyoda-ku, Tokyo (JP)

(21) Appl. No.: 13/264,640

(22) PCT Filed: May 14, 2010
(86) PCT No.: PCT/JP2010/058224

§ 371 Date: Oct. 14, 2011

(30) Foreign Application Priority Data
May 25, 2009 (JP) 2009-125440

(51) Int. Cl. B23K 26/00; B23K 26/36

(52) U.S. Cl. 219/121.78

(57) ABSTRACT

The machining device is equipped with a fiber laser oscillator for oscillating laser light of a top hat shape, and a light collecting lens and a machining head for collecting the laser light of the top hat shape and emitting the laser light onto a machining target such that the beam diameter of the laser light of the top hat shape at a position where light intensity becomes the one corresponding to a machining threshold of the machining target is about three times the size of the beam diameter of laser light in a Gaussian mode at the same position, when the laser light in the Gaussian mode has a beam quality substantially the same as that of the laser light of the top hat shape.

### FIELD

The present invention relates to a laser machining device and a laser machining method for cutting a metal plate using laser light from a high-power fiber laser oscillator.

### BACKGROUND

YAG lasers and carbon dioxide lasers are known as high-power laser oscillators used for industrial machining processes. YAG lasers and carbon dioxide lasers have different light collecting characteristics. Accordingly, YAG lasers have been used as markers or for welding, whereas carbon dioxide lasers have been used for cutting metals.

As an example, Patent Literature 1 discloses a laser cutting method using a carbon dioxide laser. The method of Patent Literature 1 sets an optical path length and the diameter of an incident beam to be variable in accordance with the thickness of a machining target (workpiece) in order to prevent unevenness in quality of a cut surface.

Meanwhile, laser machining by means of fiber lasers have actively been developed in recent years. Fiber lasers have many advantageous features that have not been achieved conventionally. For example, fiber lasers have a monolithic structure that does not require optical alignment as is required by conventional laser oscillators. Further, fiber lasers achieve energy saving for their high conversion efficiency with respect to the amount of incident light of an excited semiconductor laser, leading to high power of an oscillating laser. For their high-power and energy-saving characteristics, fiber lasers have already been used as laser markers and laser welding machines in place of conventional solid-state laser oscillators using a YAG medium and the like.

The market for machining devices used for cutting sheet metals and the like, for which carbon dioxide lasers are most widely used, is now considered to be a market on which fiber lasers are expected to spread. This is because fiber lasers are now capable of securing light collecting characteristics while maintaining high power, which is comparable to those of carbon dioxide lasers and could not be achieved by conventional YAG lasers.

### CITATION LIST

### Patent Literature

Patent Literature 1: Japanese Patent Application Laid-open No. H4-253584

### SUMMARY

### Technical Problem

Most of user's requests are directed to cutting of soft steel or iron having a thickness of 6 mm or more. However, fiber lasers have suffered from a low cutting quality of such soft steel or iron compared to conventional laser machining devices.

The present invention has been made in view of the aforementioned problems, and it is an object of the invention to provide a laser machining device and a laser machining method capable of improving the cutting quality of metal plates including medium thickness of 6 mm or more by means of a fiber laser.

### Solution to Problem

In order to solve the aforementioned problems, a laser machining device according to one aspect of the present invention is constructed in such a manner as to include: a laser oscillating unit for oscillating laser light of a top hat shape; and a light collecting unit and machining unit for collecting the laser light of the top hat shape and emitting the laser light onto a machining target such that a beam diameter of the laser light of the top hat shape at a position where light intensity becomes the one corresponding to a machining threshold of the machining target is about three times the size of a beam diameter of laser light in a Gaussian mode at the same position, wherein the laser light in the Gaussian mode has a beam quality substantially the same as that of the laser light of the top hat shape.

A laser machining device according to another aspect of the present invention is constructed in such a manner as to include: a laser oscillating unit for oscillating laser light of a top hat shape; and a light collecting unit and machining unit for collecting the laser light and emitting the laser light onto a machining target such that a focal depth at a position where light intensity becomes the one corresponding to a machining threshold of the machining target is about one-third the thickness of the machining target, wherein the focal depth indicates a range of focal positions in which a beam diameter becomes √2 times the size of a minimum beam diameter of the laser light.

### Advantageous Effects of Invention

The present invention can improve the cutting quality of metal plates including medium thickness of 6 mm or more by means of a fiber laser.

### BRIEF DESCRIPTION OF DRAWINGS

FIG. 1 is an explanatory view showing an outline of a laser cutting ands machining device using a conventional carbon dioxide laser oscillator.

FIG. 2 is a diagram showing one example of the structure of a laser machining device of a first embodiment.

FIG. 3 is a diagram representing a machined surface of a plate having a thickness of 6 mm cut under condition (1).

FIG. 4 is a diagram representing a machined surface of a plate having a thickness of 6 mm cut under condition (2).

FIG. 5 is a diagram showing a relationship between a beam shape and a machining threshold of the beam.

FIG. 6 is a diagram showing a relationship between a beam diameter and a focal position.

FIG. 7 is a diagram showing a relationship between a beam diameter and a focal position.

FIG. 8 is a diagram showing a relationship between a focal depth and a collected beam diameter.

FIG. 9 is a diagram representing a machined surface of soft steel having a plate thickness of 16 mm being cut.

FIG. 10 is a diagram showing one example of the structure of a machining head of a laser machining device of a second embodiment.

FIG. 11 is a table containing exemplary machining conditions for cutting soft steel of various thicknesses including 6 mm, 12 mm and 16 mm while a collected beam diameter is set to about 0.7 mm.

### DESCRIPTION OF EMBODIMENTS

Embodiments of a laser machining device and a laser machining method according to the present invention will be described in detail below based on the drawings. The embodiments are not intended to limit the invention.

### First Embodiment

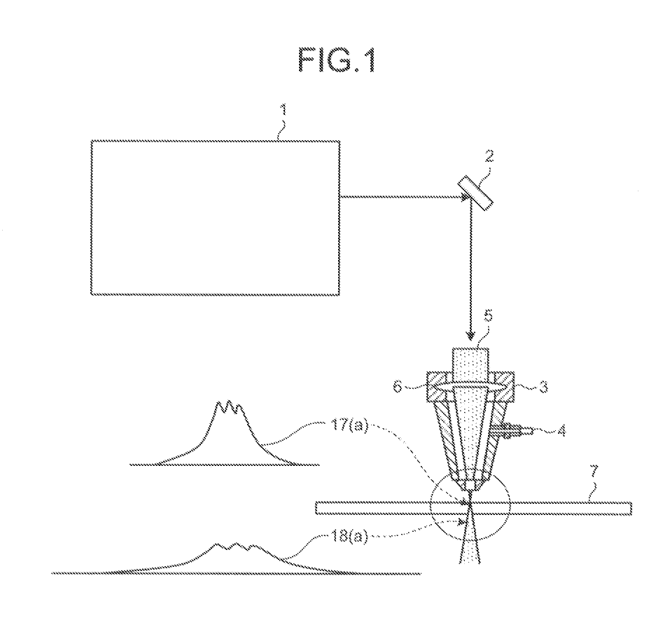

A laser cutting and machining device employing a carbon dioxide laser oscillator used for conventional cutting and machining will be described first with reference to FIG. 1. FIG. 1 is an explanatory view showing the outline of a laser cutting and machining device using a conventional carbon dioxide laser oscillator 1.

The carbon dioxide laser oscillator 1 used for cutting thick metal plates generally oscillates in a low-order Gaussian mode with an output of 4 to 6 kW. This mode indicates the quality of the beam (laser light), and a distribution of light intensity of the laser light. Heat distribution conforming to the shape of the beam is applied to a machining target in laser machining, so that the Gaussian mode is believed to be an important parameter.

As shown in FIG. 1, laser light 5 emitted from the carbon dioxide laser oscillator 1 is reflected on a mirror 2, and is then guided to a machining head 3. The machining head 3 includes a light collecting lens 6 for collecting the laser light 5, and an assist gas port 4 for causing gas to flow coaxially with the light collecting lens 6. Accordingly, the laser light 5 is collected on to a workpiece 7 and at the same time, gas is caused to flow coaxially. The laser light 5 collected on to the workpiece 7 maintains a shape in the aforementioned mode. For example, in a case where the laser light 5 in the low-order Gaussian mode is collected, the laser light 5 has a beam shape like the one shown as 17(a) at a focal point. The spread laser light 5 after the light collection has a similar beam shape to the one shown as 18(a). These are the features of the laser light 5 emitted from the carbon dioxide laser oscillator 1 conventionally used.

For collecting such laser light and cutting the workpiece 7 with the collected laser light, a controller (not shown) defines various conditions including the collected beam diameter of the laser light 5 to be emitted, type of gas, pressure of the gas, machining speed and the like.

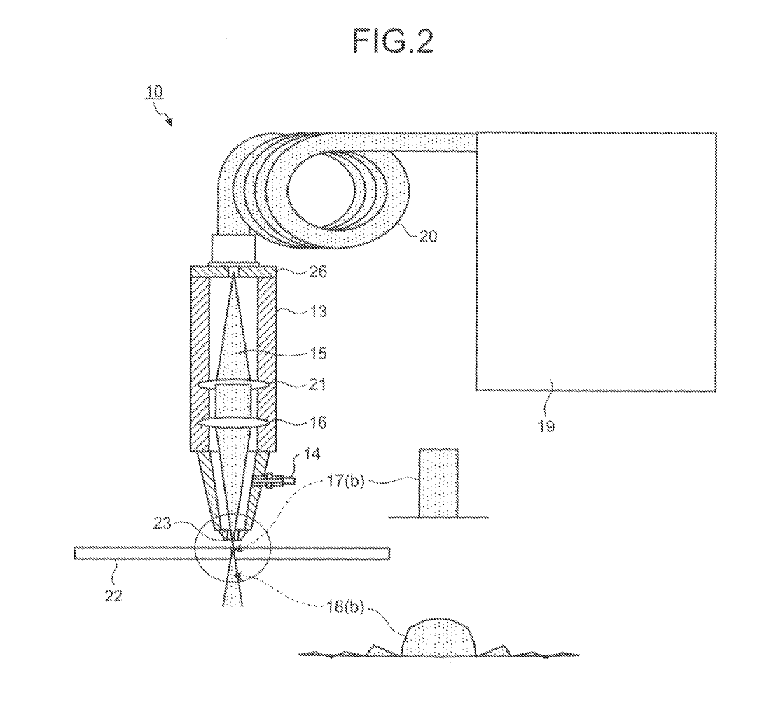

A laser machining device according to a fist embodiment using a high-power fiber laser will be described next with reference to FIG. 2. FIG. 2 is a diagram showing one example of the structure of a laser machining device 10 of the first embodiment.

As shown in FIG. 2, the laser machining device 10 includes a fiber laser oscillator 19, a fiber 20 and a machining head 13.

The fiber laser oscillator 19 emits laser light 15. The fiber 20 guides the laser light 15 oscillated by the fiber laser oscillator 19 to the machining head 13. The fiber laser oscillator 19 and the fiber 20 function as a laser oscillating means for oscillating the laser light 15 in the form of a top hat.

The machining head 13 as a machining means includes a collimator lens 21, a light collecting lens 16, an assist gas port 14 and a nozzle 23.

The collimator lens 21 converts the laser light 15 to parallel light beams. The light collecting lens 16 collects the parallel light beams, and applies the collected light beams onto a workpiece 22. The assist gas port 14 causes gas to flow coaxially with the light collecting lens 16. The nozzle 23 injects gas outputted from the assist gas port 14 onto the workpiece 22. The collimator lens 21 and the light collecting lens 16 function as light collecting means for collecting the laser light 15 in the form of a top hat, and applying the collected laser light 15 onto the workpiece 22.

A procedure of the operation of the laser machining device 10 of the present embodiment will next be described. The laser light 15 emitted from the fiber laser oscillator 19 is directly guided through the fiber 20 to the machining head 13. After exiting the fiber 20, the laser light 15 spreads once in the machining head 13. Then, the laser light 15 is converted to parallel light beams by the collimator lens 21, and is emitted to the workpiece 22 from the light collecting lens 16. During the machining operation, gas of an optimum type with an optimum flow rate is injected during machining from the assist gas port 14 through the nozzle 23 onto the workpiece 22.

As a specific example, a method of machining the workpiece 22 by oscillating the laser light 15 of approximately 5 kW from the fiber laser oscillator 19, and its result will be described below. The laser light 15 of 5 kW is transmitted through the fiber 20 having a core diameter of about 0.4 mm to the machining head 13, and is thereafter applied onto the workpiece 22. This case takes a scheme in which, based on the core diameter of the fiber 20 through which the laser light 15 has been transmitted, the laser light 15 is collected on the workpiece 22 such that the spot diameter (beam diameter) corresponding to the core diameter is transferred onto the position of the workpiece 22.

For example, if the collimator lens 21 and the light collecting lens 16 have the same focal distance, a beam diameter of 0.4 mm equivalent to the core diameter of the fiber is transferred onto a light collecting point. The collected beam diameter can be changed by changing a ratio in focal distance between the collimator lens 21 and the light collecting lens 16. A distribution of light intensity corresponding to the aforementioned mode reflects the shape of a beam within the core at an outlet 26 of the fiber 20, and has what is called a top hat shape (17(b)) showing uniform light intensity.

In the present embodiment, collection of the laser light 15 and emission of the laser light 15 onto the workpiece 22 are controlled such that the beam diameter of the collected laser light 15 at a position where light intensity becomes the one corresponding to the machining threshold of the workpiece 22 (hereinafter called threshold-equivalent beam diameter) is about three times as large as the threshold-equivalent beam diameter of the laser light 15 in the Gaussian mode having the same beam quality. This can decrease changes depending on a position in a light intensity distribution at or near a focal position corresponding to a plate thickness. As a result, the quality of a cut surface of the workpiece 22 can be improved.

In the following, an explanation as to why the quality of a cut surface can be improved by adjusting the beam diameter of the collected laser light 15 (threshold-equivalent beam diameter) oscillated by the fiber laser oscillator 19 is provided.

First, the workpiece 22 which is made of soft steel as a workpiece material and has a varying thickness in the range from a small thickness of 1 mm to a large thickness of 16 mm is cut under the following conditions (1) and (2), wherein under the condition (1), a nozzle diameter φ is 1 mm, the assist gas is oxygen, and a collected beam diameter is 0.2 mm; and under the condition (2), a nozzle diameter φ is 1 mm, the assist gas is oxygen, and a collected beam diameter is 0.3 mm. Like a conventional definition regarding a beam quality, a collected beam diameter mentioned here means a diameter at a position where about 86% of the total light amount is contained. As is explained with reference to FIG. 2, the aforementioned different conditions can be established by changing a combination of the focal distances of the collimator lens 21 and the light collecting lens 16.

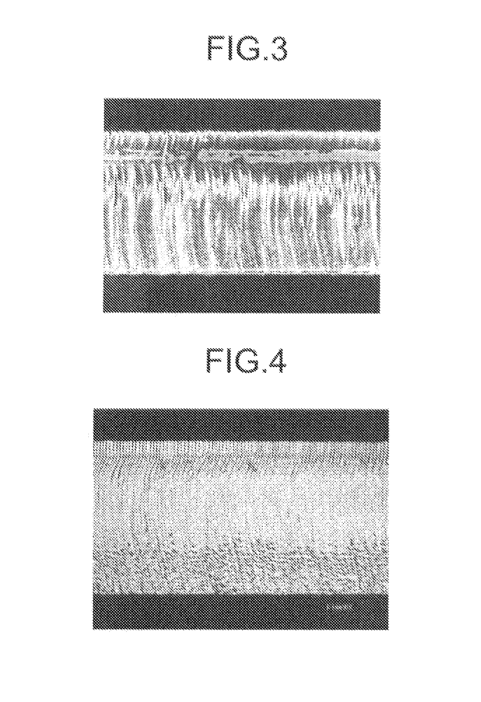

For example, in a case in which a plate thickness is small such as 3 mm or lower, there was no difference in the machining quality of the workpiece 22, namely in the state of a cut surface, while a difference was observed in the machining speed. However, a great difference was observed in the machining quality of the workpiece 22 when the plate thickness was equivalent to or larger than 6 mm. FIG. 3 is a diagram showing a machined surface of a plate having a thickness of 6 mm cut under the condition (1). FIG. 4 is a diagram showing the machined surface of a plate having a thickness of 6 mm cut under the condition (2).

Under the conditions (1) and (2), a conventional laser can cut without generating significant changes in the cutting quality. However, significant changes were observed when a fiber laser was used as shown in FIGS. 3 and 4. As shown in FIG. 3, when a collected beam diameter is 0.2 mm, roughness is generated in the upper surface of the plate, and lines of large asperities are generated in a range from the middle portion of the plate thickness to the lower surface where melting due to the combustion reaction progresses. In contrast, when the collected beam diameter is 0.3 mm, no roughness is observed in the upper surface of the plate, and a considerably good quality is maintained from the middle to the lower surface.

Generally in the case of a thin plate, heat is transferred to the lower surface of the plate only by giving heat to the front surface. Also, the thin plate is not affected by the assist gas, so that no significant difference will be generated in a cut surface. In contrast, a cut surface of the workpiece 22 of a great thickness is divided into an upper surface that is a cut surface formed by laser light itself, and a lower surface that is a cut surface formed by a combustion reaction caused by the heat of a laser and the assist gas, or by the exclusion characteristics of melted metal of the plate.

With regard especially to the lower surface, reduction in concentration of oxygen as an assist gas due to a failure in distribution of oxygen is thought to bring about serious quality deterioration such as adhesion of dross. This problem is also discussed in Patent Literature 1, for example. However, experiments conducted under the aforementioned conditions (1) and (2) reveal the fact that varying the pressure of assist gas will not provide significant improvement, and that a large difference is generated in the states of the upper surface of the machined plate as shown in FIGS. 3 and 4. Accordingly, it was considered that laser light itself might be influential in some way.

Therefore, the light collecting characteristics of laser light were examined, and results obtained therefrom will be described next. As described above, in order to form a light collecting optical system using a fiber laser, an image transferring optical system for transferring the shape of a beam in the core at the outlet 26 of the fiber 20 to a focal position is used.

Accordingly, the shape of a beam at a light collecting point is expected to be similar to the shape of the beam at the outlet 26 of the fiber 20, namely the top hat shape shown by 17(b) in FIG. 2. However, it was found out that the shape of the beam actually observed after the light collection is distorted, and changed into a shape having diffracted light as shown by 18(b) in FIG. 2.

In many cases, a beam having such light intensity as of a top hat beam is desired in the electronic technical field such as marking and boring. The reason therefor is because marking and boring are machining processes performed on a surface layer of about 1 mm or less of the surface of a machining target, and also because as a top hat beam achieves uniform light intensity compared with a conventional laser, the light intensity distribution of the beam itself can be reflected clearly on the surface of a material to be machined. To be specific, a beam having such a light intensity as of a top hat beam is not used for machining at a position spaced several millimeters away from a focal position. However, it is probable that for laser cutting of the workpiece 22 of a medium thickness, the workpiece 22 may be cut while heat is given deeper also in a direction of the thickness of the workpiece 22. Accordingly, an influence on machining process that is to be exerted by the shape of a beam at the positions before and after the light collecting point, for example, near the transferring point before a cut width is formed in the surface should have been considered.

In the conventional laser cutting, light of a minute amount such as a noise from a laser oscillator generated for some reason may be collected on the material surface to cause an influence on a machining quality. This influence is observed especially in high-power and high-speed cutting, or in the case of machining a thick material. With regard especially to cutting of soft steel or iron, light intensity reaches a level of megawatts per square centimeter (MW/cm2) or higher at the center position where a Gaussian beam of a kW output level is collected. In this case, light of a small amount is not deemed to be influential. However, light intensity of several tens of kilowatts per square centimeter (KW/cm2) that is believed to be a machining threshold should be considered in order to take the quality of a machined surface into account.

In the present embodiment, it is quite probable that light intensity equivalent to such a machining threshold is generated in the inner surface of a machined material, and causes adverse effect on the machined surface. Accordingly, the change of a beam diameter at the positions near a focal point was examined.

As an example, calculation was made with an intention of achieving a collected beam diameter of 0.2 mm, using a fiber laser of 5 kw. Like a conventional definition applied to define a beam quality, a collected beam diameter mentioned here is defined as a diameter at a position where about 86% of the total light amount is contained. In this case, if the same light collecting optical system is used with respect to both a low-order Gaussian beam and a top hat beam, they certainly produce the same collected beam diameter.

Accordingly, in the present embodiment, the behavior of a beam having light intensity of a machining threshold is considered. If the workpiece 22 is soft steel or iron, a machining threshold indicating minimum required light intensity for its machining is about 50 kW/cm². This means that soft steel and iron are metal materials having a low machining threshold.

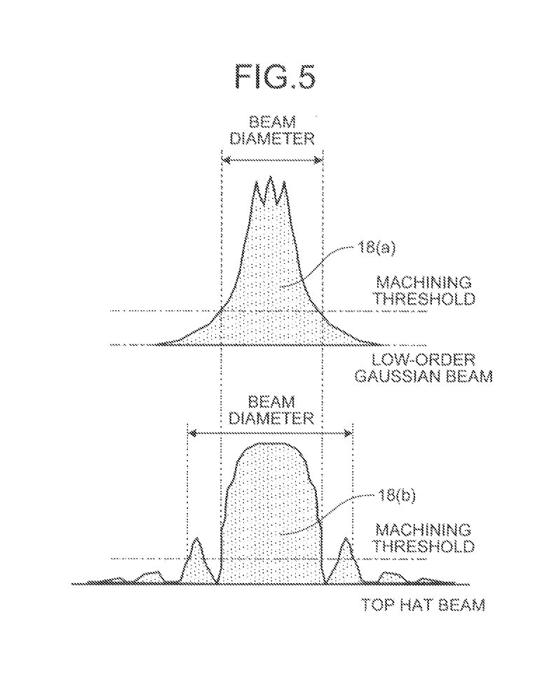

FIG. 5 is a diagram showing a relationship between a beam shape and a machining threshold of the beam regarding each of a low-order Gaussian beam (18(a)) and a top hat beam (18(b)). As shown in FIG. 5, when diffracted light appears in the top hat beam, the beam diameter of the top hat beam defined by the position at the outermost circumference which exceeds a machining threshold is largely different from that of the low-order Gaussian beam.

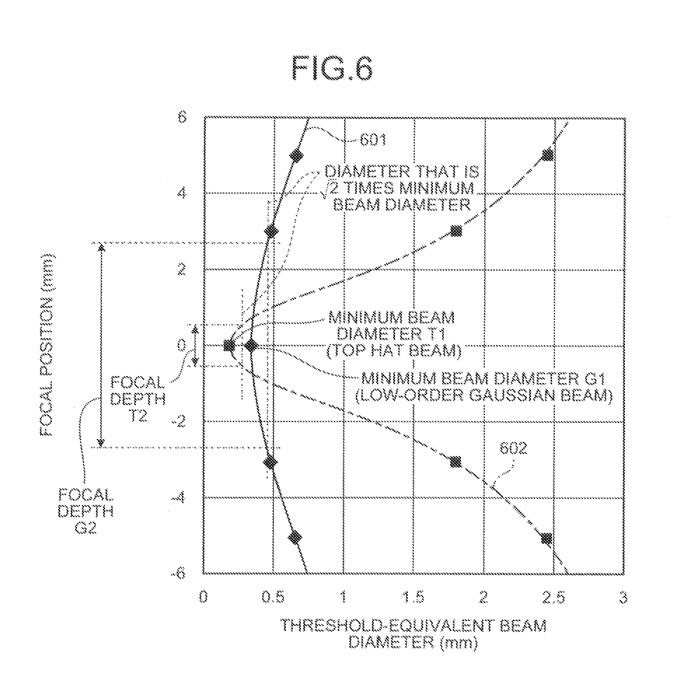

FIG. 6 is a diagram showing a relationship between a beam diameter and a focal position established when a diameter at the outermost circumference at which light intensity corresponds to a machining threshold is defined as a beam diameter (threshold-equivalent beam diameter). A solid line 601 of FIG. 6 shows a relationship regarding a low-order Gaussian beam obtained from a conventional laser oscillator. A dashed line 602 of FIG. 6 shows a relationship regarding a top hat beam such as a fiber laser. The Gaussian beam used for a conventional laser has such transmission characteristics that maintain the same shape at a light collecting point. Accordingly, a beam diameter with light intensity corresponding to a machining threshold (threshold-equivalent beam diameter) is varied little by the change of a focal position.

In contrast, the above-mentioned diffracted light appears in a top hat beam such as a fiber laser. Accordingly, the beam in a rectangle shape is well narrowed at or near the focal position of a minimum beam diameter. On the other hand, diffraction light of high light intensity is generated at the focal positions before and after the focal position of the minimum beam diameter. Thus, a threshold-equivalent beam diameter tends to increase in proportion to the distance from the focal position of the minimum beam diameter and its nearby positions.

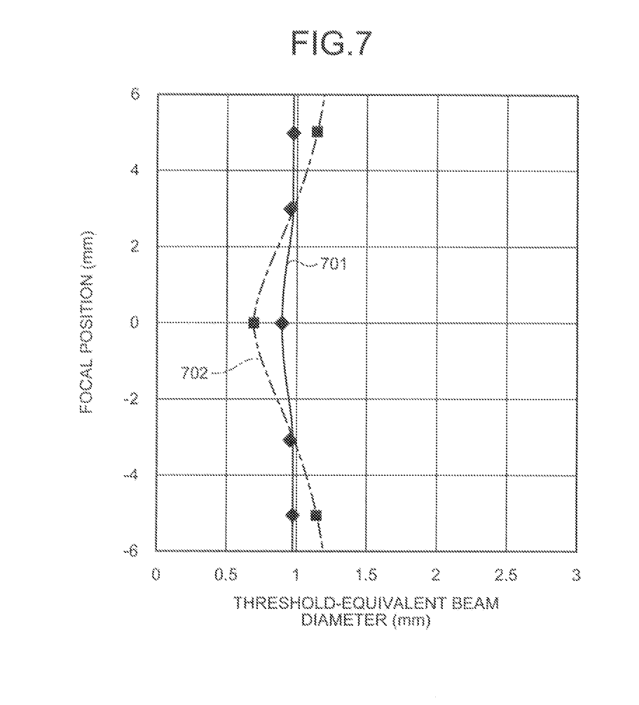

Next, a calculation was made while maintaining an output at 5 kW, so that a collected beam diameter should be made about 0.7 mm. The workpiece 22 is assumed to be soft steel as in the case of FIG. 6. Further, a diameter at the outermost circumference at which light intensity becomes 50 kW/cm² that is a minimum required machining threshold for machining is defined as a beam diameter (threshold-equivalent beam diameter). FIG. 7 is a diagram showing a relationship between a beam diameter and a focal position established in this case. In FIG. 7, a solid line 701 shows a relationship regarding a low-order Gaussian beam, and a dashed line 702 shows the relationship regarding a top hat beam. As shown in FIG. 7, compared with the case of FIG. 6 where light is collected to be 0.2 mm, a threshold-equivalent beam diameter varies less along with a focal point in the low-order Gaussian mode. Regarding the top hat beam, diffraction light with high light intensity is not generated, and the top hat beam is subjected to vary in a similar manner to that of the low-order Gaussian beam.

Next, a relationship between the aforementioned change and a focal depth will be considered. A focal depth is generally defined by the depth of a focal point that reaches a depth which is √2 times as large as a minimum beam diameter. By referring, for example, to FIG. 6, the minimum beam diameters of the top hat beam and the low-order Gaussian beam are shown as minimum beam diameters T1 and G1, respectively. Beam diameters that are √2 times the size of these minimum beam diameters are placed on the corresponding dotted lines. The distance between two focal positions that are points of intersection of each of the dotted lines and a corresponding curve line showing the variation of a threshold-equivalent beam diameter corresponds to the focal depth. As indicated by dotted-line arrows in FIG. 6, the focal depths of the top hat beam and the low-order Gaussian beam are focal depths T2 and G2, respectively.

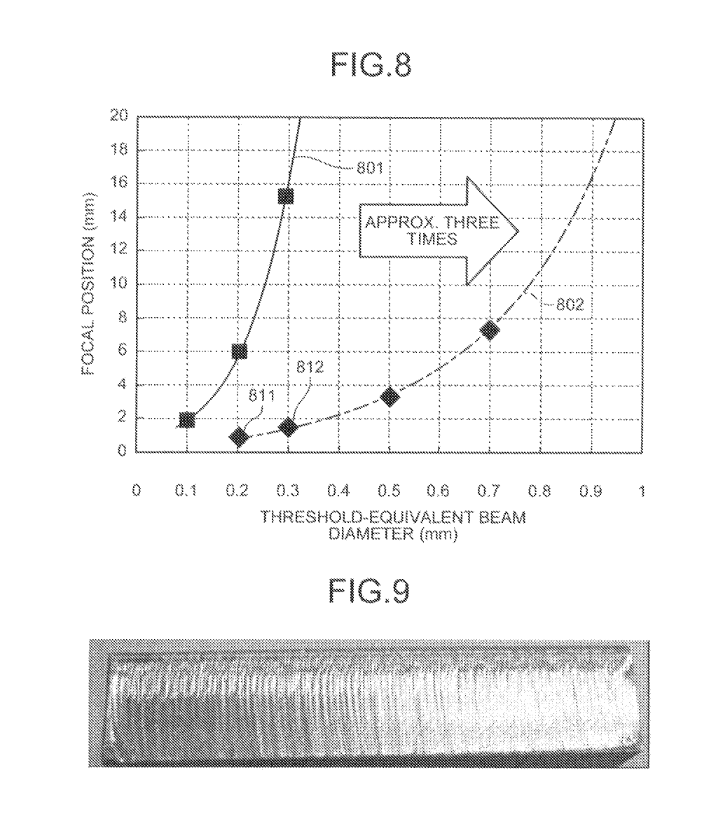

By extending the same analysis on different focused beam diameters such as those of FIG. 7, the relationship between the diameter of each collected beam (threshold-equivalent beam diameter) and a focal depth are obtained. FIG. 8 is a diagram showing the relationship thereby obtained between a focal depth and a collected beam diameter (threshold-equivalent beam diameter). In FIG. 8, a solid line 801 shows a relationship regarding a conventional low-order Gaussian beam, and a dashed line 802 shows a relationship regarding a top hat beam oscillated by a fiber laser and the like.

It is understood from FIG. 8 that the focused beam diameter (threshold-equivalent beam diameter) of the top hat beam should be made as large as about three times that of the low-order Gaussian beam in order for the top hat beam to have the same beam quality as that in the low-order Gaussian mode, and to secure a focal depth defined by a machining threshold at substantially the same level.

The machining results shown in FIGS. 3 and 4 can be explained with reference to FIG. 8. To be specific, a focal depth is only about 0.5 mm as indicated by point 811 if a focused beam diameter is 0.2 mm (FIG. 3). Accordingly, serious roughness is generated in an upper surface itself. If the focused beam diameter is increased to 0.3 mm (FIG. 4), the focal depth is made greater to about 2 mm as indicated by point 812. Thus, a machining quality of a cut surface is secured in the upper surface. In other words, a favorable machining quality can be obtained. It is thus understood that a focal depth of about one-third the size of a plate thickness is required in order to cut a plate with a thickness of 6 mm using a top hat beam such as a fiber laser with high-level of machining quality.

Results of a cutting test conducted on soft steel of 16 mm by employing the method of the present embodiment will now be described.

It is assumed that the machining quality can be more secured with a greater focal depth. However, increasing a focal depth excessively results in reduction in light intensity at a light collecting part, leading thus to a reduction in machining speed. Accordingly, a collected beam diameter was set to about 0.7 mm based on FIG. 8 in order to secure a focal depth at 5 mm that is about one-third the size of the plate thickness, or more. As described above, the collected beam diameter can be set, for example, by changing a ratio in focal distance between the collimator lens 21 and the light collecting lens 16.

FIG. 9 is a diagram showing a cut surface of soft steel having a thickness of 16 mm cut in the aforementioned manner. As seen from FIG. 9, surface roughness (Ry) obtained at a machining speed of 1.4 m/min was about 20 μm in all of the upper, middle and lower surfaces of the plate, so that a favorable quality was secured. This means that the machining quality obtained at a machining speed substantially the same as that of a conventional carbon dioxide laser is same as or higher than that obtained by the carbon dioxide laser. Thus, even a fiber laser considered to have a lower machining quality can secure the machining quality at a satisfactory level by taking the behavior of a beam of light into account.

A focal depth corresponding to a plate thickness is a condition satisfied in a generally employed machining optical system in the case of a conventional Gaussian beam. Thus, a fiber laser producing the same beam quality was believed to achieve substantially the same focal depth. However, in the case of a metal plate with a thickness of about 6 mm or more, it was found out that a beam diameter at or near a focal point is very influential, leading to deterioration in machining quality.

In view of this, it was found that a collected beam diameter (threshold-equivalent beam diameter) should be from 0.3 mm to 0.7 mm at a focal depth that is about one-third the size of a plate thickness in order to cut a medium thickness plate having a thickness of about 6 mm to about 16 mm while maintaining a machining quality. That is, it was found out that a collected beam diameter (threshold-equivalent beam diameter) should be three times as large as or more than that of a conventional Gaussian laser. This condition is different from the condition for laser machining in the conventional Gaussian mode, and is a light collecting condition required for laser machining determined by the beam characteristics themselves of a fiber laser.

From the view point of machining speed as well, the aforementioned collected beam diameter of 0.7 mm may be a maximum collected beam diameter required for cutting a material of up to 16 mm in consideration of a machining quality using a fiber laser.

FIG. 11 is a table containing exemplary machining conditions for cutting soft steel of various thicknesses including 6 mm, 12 mm and 16 mm while a collected beam diameter is set to about 0.7 mm. Here, machining conditions applied include laser output, plate thickness, machining speed, gas pressure, gas type, diameter of the nozzle 23 (nozzle diameter), a distance between the nozzle 23 and the workpiece 22 (nozzle height), and a distance between a focal point and the workpiece 22 (focal position) at the time of machining. The machining quality is given in the form of surface roughness achieved under these machining conditions. The result of machining largely differs depending on machining conditions set up during the machining operation. Accordingly, the conditions mentioned here are each quite important to achieve the effect of the present embodiment.

The margin of about 2 mm for a focal point could be obtained while the machining quality (surface roughness) was kept at a level equivalent to that of a conventional laser machining device. Further, it was shown that cutting can be made at a cutting speed of 1 m/min or higher which is equivalent to that or higher than that of conventional laser machining.

Thus, the present embodiment can decrease changes along with the position in a light intensity distribution or near the focal position corresponding to a plate thickness. As a result, the quality of a cut surface of the workpiece 22 can be improved. The use of laser light that is a top hat beam obtained from an oscillator makes it possible to cut a metal plate, especially metal plate of a medium thickness having 6 mm or more into a desirable shape while maintaining a surface quality.

### Second Embodiment

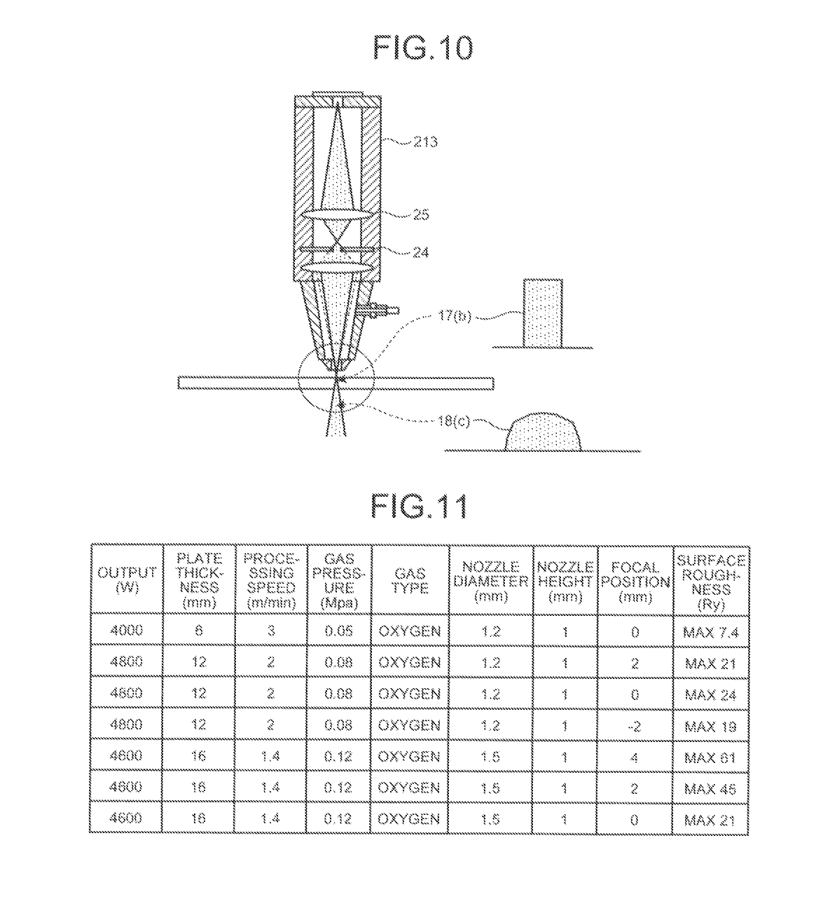

FIG. 10 is a diagram showing one example of the structure of a machining head 213 of a laser machining device of a second embodiment. The structure of the machining head 213 as a machining means is formed by modulating the machining head 13 of the first embodiment. FIG. 10 shows an exemplary structure in which a beam correcting lens 25 inside the machining head 213 collects light emitted from the fiber 20 once, and in which an aperture 24 is provided near the light collecting point.

As described above, diffracted light that is spread with higher light intensity than a machining threshold adversely affects the machining quality. Thus, the beam correcting lens 25 collects a part of light with high light intensity spreading from a top hat beam such as that shown as the one shown by 17(b) toward the periphery, and the aperture 24 removes the collected part. Thereafter, the light is collected again, and is applied onto the workpiece 22 for machining. In FIG. 10, a beam shape formed after the top hat beam is collected by the machining head 213 of the second embodiment is shown as 18(c).

If it is assumed, for example, that the behavior of a beam collected by the beam correcting lens 25 is like the aforementioned characteristics of the top hat beam of FIG. 8, the aperture 24 having a diameter of about φ0.5 mm to about φ1 mm is formed at a position distanced from a focal position by 2 mm or more. This can remove, or reduce a part of light having high light intensity that becomes diffracted light. Thus, like a conventional Gaussian beam, even a top hat beam can decrease changes in light intensity at or near the focal position. This realizes an acquisition of a focal depth equivalent to that conventionally acquired even if the beam diameter of collected light is substantially the same as the conventional diameter, thereby allowing an improvement in a laser cut surface of a medium thickness plate of 6 mm or more.

As a method for removing or reducing diffracted light by the aperture 24, any conventionally employed methods are applicable including absorption of diffracted light and reflection of diffracted light. The aforementioned advantageous effect can also be achieved by using an optical element in place of the aperture 24 that causes a part other than diffracted light to pass therethrough.

As mentioned heretofore, the laser machining devices of the first and second embodiments are means useful for improving the quality of a machined surface in laser machining using an energy-saving and high-power fiber laser. In order to achieve machining in which a machining quality is secured, a light collecting optical system that takes into consideration the reduction in light intensity corresponding to the machining threshold of a material to be machined within a range of focal point appropriate for the thickness of a plate to be machined, as well as the reduction in light intensity corresponding to a machining threshold at a focal position, should be provided. In each of the embodiments described above, machining of a cutting quality equivalent to or higher than the conventional cutting quality is enabled in consideration of a change in light intensity with a view to reducing an influence to be exerted by the change in light intensity.

In the laser machining described in the first and second embodiments, a fiber laser is adopted as an example. However, a high-power laser oscillation source having light collecting characteristics equivalent to those of a carbon dioxide laser is also applicable if it involves fiber transmission and can be used for cutting process. The aforementioned advantageous effects in the laser machining of the first and second embodiments can also be achieved, for example, by applying various types of solid-state lasers involving fiber transmission, semiconductor lasers such as fiber couplers and so on.

In the laser machining explained heretofore, soft steel is described as an example of a workpiece. However, other types of metal plates including iron and stainless steel are also applicable to machining plates of medium thickness which is a thickness of 6 mm or more.

The description of each of the above embodiments is given as an example. Each of the above embodiments may be implemented in combination with a different publicly known technique. Also, the structure of each of the above embodiments may be omitted or modified without departing from the scope of the invention.

### INDUSTRIAL APPLICABILITY

As described above, the laser machining device and the laser machining method according to the present invention are suitably applied to a laser machining device and method for cutting a metal plate, especially of a medium thickness by means of laser light of a top hat beam obtained from a high-power fiber laser oscillator.

### REFERENCE SIGNS LIST

1 CARBON DIOXIDE LASER OSCILLATOR
2 MIRROR
3 MACHINING HEAD
4 ASSIST GAS PORT
5 LASER LIGHT
6 LIGHT COLLECTING LENS
7 WORKPIECE
10 LASER MACHINING DEVICE
13, 213 MACHINING HEAD
14 ASSIST GAS PORT
15 LASER LIGHT
16 LIGHT COLLECTING LENS
17(a) BEAM SHAPE AT A LIGHT COLLECTING POINT OF A GAUSSIAN BEAM IN THE FIRST EMBODIMENT
17(b) BEAM SHAPE AT A LIGHT COLLECTING POINT OF A TOP HAT BEAM IN THE FIRST EMBODIMENT
18(a) BEAM SHAPE AFTER THE COLLECTION OF GAUSSIAN BEAMS IN THE FIRST EMBODIMENT
18(b) BEAM SHAPE AFTER THE COLLECTION OF TOP HAT BEAMS IN THE FIRST EMBODIMENT
18(c) BEAM SHAPE AFTER THE COLLECTION OF TOP HAT BEAMS IN THE SECOND EMBODIMENT
19 FIBER LASER OSCILLATOR
20 FIBER
21 COLLIMATOR LENS
22 WORKPIECE
23 NOZZLE
24 APERTURE
25 BEAM CORRECTING LENS
26 OUTLET

1-14. (canceled)

15. A laser machining device, comprising:
a laser oscillating unit for oscillating laser light of a top hat shape; and
a light collecting and machining unit for collecting the laser light of the top hat shape and emitting the laser light onto a machining target such that a beam diameter of the laser light of the top hat shape at a position where light intensity becomes the one corresponding to a machining threshold of the machining target is about three times the size of a beam diameter of laser light in a Gaussian mode at the same position, the laser light in the Gaussian mode having a beam quality substantially the same as that of the laser light of the top hat shape.

16. The laser machining device according to claim 15, wherein the beam quality is such that beam diameters at a position to which about 86% of a total amount of light are equivalent to each other.

17. A laser machining device, comprising;
a laser oscillating unit for oscillating laser light of a top hat shape; and
a light collecting and machining unit for collecting the laser light and emitting the laser light onto a machining target such that a focal depth at a position where light intensity becomes the one corresponding to a machining threshold of the machining target is about one-third the thickness of the machining target, the focal depth indicating a range of focal positions in which a beam diameter becomes √2 times the size of a minimum beam diameter of the laser light.

18. The laser machining device according to claim 17, wherein the machining target is soft steel or iron.

19. The laser machining device according to claim 17, wherein the machining target is made of a material, the light intensity of which corresponding to the machining threshold is about 50 kW/cm² or higher.

20. The laser machining device according to claim 17, wherein the laser oscillating unit includes any one of a fiber laser, a fiber coupled semiconductor laser, and a solid-state laser involving fiber transmission.

21. A laser machining method, comprising:
a laser oscillating step for oscillating laser light of a top hat shape; and
a light collecting step for collecting the laser light of the top hat shape and emitting the laser light onto a machining target such that a beam diameter of the laser light of the top hat shape at a position where light intensity becomes the one corresponding to a machining threshold of the machining target is about three times the size of a beam diameter of laser light in a Gaussian mode at the same position, the laser light in the Gaussian mode having a beam quality substantially the same as that of the laser light of the top hat shape.

22. A laser machining method, comprising:
a laser oscillating step for oscillating laser light of a top hat shape; and
a light collecting step for collecting the laser light and emitting the laser light onto a machining target such that a focal depth at a position where light intensity becomes the one corresponding to a machining threshold of the machining target is about one-third the thickness of the machining target, the focal depth indicating a range of focal positions in which a beam diameter becomes √2 times the size of a minimum beam diameter of the laser light.

23. The laser machining method according to claim 22, wherein a laser output in the laser oscillating step is set to be 4 to 5 kW, and the diameter of a beam collected in the light collecting step is set to about 0.7 mm if the machining target has a thickness of 6 mm to 16 mm.

24. The laser machining method according to claim 23, wherein a nozzle for injecting gas onto the machining target has a diameter of 1.2 to 1.5 mm, and a gas pressure is 0.05 to 0.12 Mpa.

25. The laser machining device according to claim 23, wherein the machining target is made of a material, the light intensity of which corresponding to the machining threshold is about 50 kW/cm² or higher.

26. The laser machining method according to claim 22, wherein in the laser oscillating step any one of a fiber laser, a fiber coupled semiconductor laser, and a solid-state laser involving fiber transmission is used.

27. The laser machining device according to claim 15, wherein the machining target is soft steel or iron.

28. The laser machining device according to claim 15, wherein the machining target is made of a material, the light intensity of which corresponding to the machining threshold is about 50 kW/cm² or higher.

29. The laser machining device according to claim 15, wherein the laser oscillating unit includes any one of a fiber laser, a fiber coupled semiconductor laser, and a solid-state laser involving fiber transmission.

30. The laser machining method according to claim 21, wherein a laser output in the laser oscillating step is set to be 4 to 5 kW, and the diameter of a beam collected in the light collecting step is set to about 0.7 mm if the machining target has a thickness of 6 mm to 16 mm.

31. The laser machining method according to claim 30, wherein a nozzle for injecting gas onto the machining target has a diameter of 1.2 to 1.5 mm, and a gas pressure is 0.05 to 0.12 Mpa.

32. The laser machining device according to claim 30, wherein the machining target is made of a material, the light intensity of which corresponding to the machining threshold is about 50 kW/cm² or higher.

33. The laser machining method according to claim 21, wherein in the laser oscillating step any one of a fiber laser, a fiber coupled semiconductor laser, and a solid-state laser involving fiber transmission is used.
